(19) United States
(12) Patent Application Publication
(10) Pub. No.: US 2026/0005522 A1
(43) Pub. Date: Jan. 1, 2026

(54) OVER-VOLTAGE PROTECTION FOR SAFE OPERATION OF STRINGS INCLUDING A NUMBER OF SOLAR PANELS BEYOND A RATED MAXIMUM NUMBER

(71) Applicant: Inventus Holdings, LLC, Juno Beach, FL (US)

(72) Inventors: Tanvir E. ALAM, Palm Beach Gardens, FL (US); Daniel J. MARIENI, North Palm Beach, FL (US); Partho Sarothi ROY, Riviera Beach, FL (US); Maikel MARTIN, Lake Worth, FL (US); Matthew L. BARROWS, Jupiter, FL (US)

(21) Appl. No.: 18/756,720

(22) Filed: Jun. 27, 2024

(51) Int. Cl. H02J 3/46; G01W 1/02; G05D 3/10; H02J 3/00; H02S 50/00

(52) U.S. Cl. CPC H02J 3/466; G01W 1/02; G05D 3/105; H02J 3/001; H02S 50/00; H02J 2300/24

(57) ABSTRACT

A system and method for safe operation of a tracking solar array field during extreme and non-extreme operating conditions. A plurality of strings of tracking solar panels are electrically connected to a combiner box that produces a combined variable operating DC voltage at an input of an inverter. A total number of the solar panels in a string exceeds a rated maximum number of solar panels to maintain variable operating DC voltage below a rated maximum DC voltage during extreme operating conditions that cause the variable DC voltage to exceed the rated maximum DC voltage. If extreme operating conditions are imminent, the method reduces the variable DC voltage to below the rated maximum DC voltage by switching in a shunt load at the input of the inverter, or switching in a shunt load at the output of the combiner box; or tilting operating tracking solar panels to a solar stow tilt position.

### FIELD OF THE DISCLOSURE

The present invention generally relates to photovoltaic solar farms, and more particularly to managing safe photovoltaic power distribution between strings of solar panels and power inverters of such solar farms.

### BACKGROUND

Solar Photovoltaic (PV) electric generation sites, which are referred to herein as solar farms or solar array fields, or the like, have a plurality of solar panels that each includes a number of solar cells to generate DC power that is provided by distribution through the solar farm to one or more inverters for conversion to AC power that is provided as an output of the solar farm. For example, solar farms can generate AC electric power that is coupled through power company equipment into the power distribution grid.

Generally, a solar farm (solar array field) has a large number of photovoltaic panels (PV's), which can also be referred to herein as PV modules, solar panels, and the like, that are organized in one or more strings of PV's. The output DC voltage and current from a plurality of strings is combined through a combiner box. The output DC voltage and current from a plurality of combiner boxes can be further combined into an input of a power inverter (also referred to herein as inverter) that converts DC power at its input to AC power at its output. A solar farm can provide DC power from groups of solar panel strings to respective inverters (e.g., 100 or more inverters) that each produces output AC power. Power transmission equipment such as transformers, switchgear equipment, and substations, couple the AC power output from one or more inverters into a power distribution grid.

The size of each of the strings, i.e., the total number of operational PV's in a string, has been typically limited by design according to an industry-rated maximum input DC voltage of the inverter. This rated maximum input voltage is issued by the power industry to maintain safe operation of the power generating equipment. The total output DC voltage from a group of strings is designed to stay within a rated maximum input DC voltage into the inverter, and the rated maximum DC voltage similarly applies to all electrical components in between the output of the string of PV's and the input to the inverter.

The rated maximum input DC voltage is designed for all anticipated weather and ambient temperature and solar irradiance conditions affecting the solar cells in solar panels, the PV's, and other interconnecting electrical components in the solar farm. This industry-rated maximum output DC voltage from each string of PV's is aimed to prevent a catastrophic over-voltage condition at the combiner boxes and at the input of the inverter, which could damage the DC power generating equipment, such as the output of a string of PV's, the combiner box(es), the inverter(s), and interconnecting cabling, fuses or circuit breakers, and other electrical components in between the PV's and the inverter input.

### BRIEF DESCRIPTION OF THE SEVERAL VIEWS OF THE DRAWINGS

The accompanying figures, in which like reference numerals refer to identical or functionally similar elements throughout the separate views, and which together with the detailed description below are incorporated in and form part of the specification, serve to illustrate various examples and to explain various principles and advantages all in accordance with the present disclosure, in which:

FIG. 1 is an illustrative example of a power generating solar farm (solar array field), according to various embodiments of the invention;

FIG. 2 is an example of a string of PV's in the solar farm of FIG. 1;

FIG. 3 is a more detailed example of tracking photovoltaic panels shown in FIG. 1, according to various embodiments of the invention;

FIG. 4 is a block diagram showing two examples of using a safety shunt load (e.g., shunt resistance) electrical component, according to various embodiments of the invention;

FIG. 5 is a more detailed block diagram of the second example of FIG. 4;

FIGS. 6 and 7 are operational flow diagrams illustrating a first example set of operations of the system of FIG. 1, according to various embodiments of the invention;

FIGS. 8 and 9 are operational flow diagrams illustrating a second example set of operations of the system of FIG. 1, according to various embodiments of the invention;

FIGS. 10 and 11 are operational flow diagrams illustrating a third example set of operations of the system of FIG. 1, according to various embodiments of the invention;

FIG. 12 is a block diagram illustrating an example information processing system suitable for use in a photovoltaic power safety controller such as shown in FIG. 1, according to various embodiments of the invention;

FIG. 13 is a table illustrating several example projects including different maximum string sizes and associated overvoltage events per year; and

FIG. 14 is a table illustrating two example projects with several different string sizes and associated open circuit voltage and operating voltage.

### DETAILED DESCRIPTION

As required, detailed embodiments are disclosed herein; however, it is to be understood that the disclosed embodiments are merely examples and that the devices, systems, and methods described herein can be embodied in various forms. Therefore, specific structural and functional details disclosed herein are not to be interpreted as limiting, but merely as a basis for the claims and as a representative basis for teaching one of ordinary skill in the art to variously employ the disclosed subject matter in virtually any proprietary detailed structure and function. Further, the terms and phrases used herein are not intended to be limiting, but rather, to provide an understandable description. Additionally, unless otherwise specifically expressed or clearly understood from the context of use, a term as used herein describes the singular and/or the plural of that term.

### Introduction

The inventors have observed that in many operating environments the number of solar panels in a string is designed to maintain input voltage at an inverter to below an industry-rated maximum DC voltage at the inverter input during extreme ambient temperature (e.g., historically lowest ambient temperatures at a solar farm site, which can be for example approximately −10 degrees Centigrade or lower) and extreme solar irradiance conditions (e.g., historically highest solar irradiance values at a solar farm site, which can be approximately 800 W/m² or higher). These extreme conditions, however, do not occur in many operating environments of solar array fields during most times during the year. A string size (i.e., the total number of operational solar panels in a string) is typically designed for safe operation even under extreme conditions, to maintain an inverter input DC voltage below an industry-rated maximum DC voltage under all operating conditions. This industry practice results in reduced efficiency of power generation during most operating times. That is, the industry-rated maximum DC voltage at the input of the inverter limits the number of operational PV's in a string, typically generating much lower output DC voltage (and power) than could be generated under non-extreme conditions.

The loss in efficiency significantly increases the operating costs of the power generation industry. To compensate for the reduced efficiency, operators have increased the number of strings, the number of combiner boxes, and all associated power distribution electrical components and equipment, in a solar farm. This increase in operating costs detrimentally impacts the commercial viability of an operating solar farm.

There are a number of benefits to increasing the string size, such as: 1) reduced capital costs by optimizing the balance of a system in a solar farm; 2) can use less rows of tracker PV's; 3) can use less cabling, less combiner boxes, less trenching, etc.; 4) can increase energy production from a solar farm; 5) there are less losses when running at a higher DC voltage from the outputs of PV strings to the input of inverter(s); and 6) it can reduce occurrences of low-voltage inverter shutoffs.

The importance of safe operation of the PV's, and of all electrical components from the string of PV's to the inverter, in a solar farm (solar array field) cannot be overstated. The inventors describe below various embodiments that allow the benefit of increasing the number of operational PV's in a string (beyond the rated maximum number) during most operating conditions for a solar farm, while protecting against an over-voltage condition during extreme conditions which typically occur infrequently in most operating environments.

### Description of Various Example Embodiments

The below-described examples of systems and methods provide various technical solutions for more efficiently operating a solar farm (solar array field) during most operating conditions for a solar farm, while protecting against an over-voltage condition during extreme conditions.

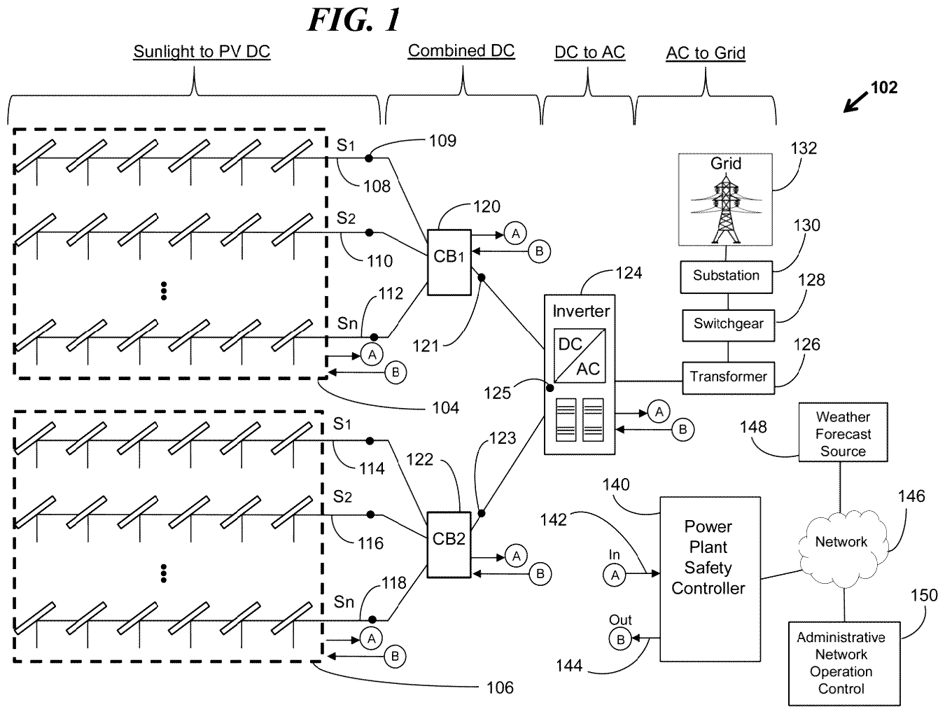

Referring to FIG. 1, an example of a photovoltaic electrical power generation system (also referred to as solar power generation equipment, photovoltaic electrical power generation system, and the like) 102 is shown, according to various embodiments of the invention. The system 102, in this example, comprises a solar farm (solar array field) including, in this example, two groups 104, 106, of photovoltaic panels (also referred to as PV's, tracker solar panels, or solar panels, or the like) that track the movement of the sun from East to West across the sky and harvest solar power. The tracker solar panels in the first group 104 are organized in several strings S1 108, S2 110, Sn 112. Similarly, the tracker solar panels in the second group 106 are organized in several strings S1 114, S2 116, Sn 118. The output of each string is indicated by a solid circle symbol; for example, the first string S1 108 has an output at the solid circle symbol 109. In the present discussion, the output 109 of the first string 108 may be also representative of an output of one or more strings in context of the discussion.

The several strings 108, 110, 112, in the first group 104 are combined, in the example, by a first combiner box 120 which receives the harvested solar power as variable DC voltage and current from an output of the one or more strings of PV's. The several strings 114, 116, 118, in the second group 106 are combined by a second combiner box 122 which receives the harvested solar power as variable DC voltage and current from an output of the one or more strings of PV's. The output 121 of the first combiner box 120 and the output 123 of the second combiner box 122 are interconnected to an input 125 of an inverter 124. The output of each combiner box 120, 122, is indicated by a solid circle symbol 121, 123. The output 121, 123, of each combiner box 120, 122, provides variable DC voltage and current combined from an output of one or more strings of PV's. The variable DC voltage and current from each output 121, 123, of the combiner boxes 120, 122, is combined in the input 125 into the inverter 124. The output of the inverter 124 is coupled to a transformer 126. The transformer 126 is coupled to switchgear equipment 128. The switchgear equipment 128 is coupled to a substation 130. The substation 130 is coupled to an electrical power generation grid 132.

A photovoltaic power plant safety controller 140, in this example, is coupled (e.g., via computer network and/or link) to a solar panel controller (not shown) at one or more of the tracker solar panels. The solar panel controller is coupled to one or more sensors at the respective solar panel. A solar cell temperature sensor, for example, monitors the temperature of a solar cell in a solar panel. An ambient temperature sensor, as a second example, monitors the ambient temperature in close proximity to a solar panel. An irradiance sensor, as third example, monitors a level of irradiance of sunlight from the sun at the surface of solar cells in the solar panel which are facing the sun. A tilt angle sensor, as fourth example, monitors the tilt angle on the solar panel which can change, for example, as the face of the solar panel tracks the sun moving across the sky.

The tilt angle sensor, according to various embodiments, can monitor a solar stowing position for the solar panel. The solar stowing position of the solar panel indicates that the solar panel is tilted at an angle away from directly facing sunlight from the sun. By tilting the solar panel away from the sun, in the solar stowing position, the solar panel stops tracking the sun and the photovoltaic voltage/current from the solar panel is significantly reduced, possibly down to zero. This movement of the solar panel away from direct sunlight from the sun effectively reduces, or removes, the solar panel's contribution of voltage/current to its string of solar panels.

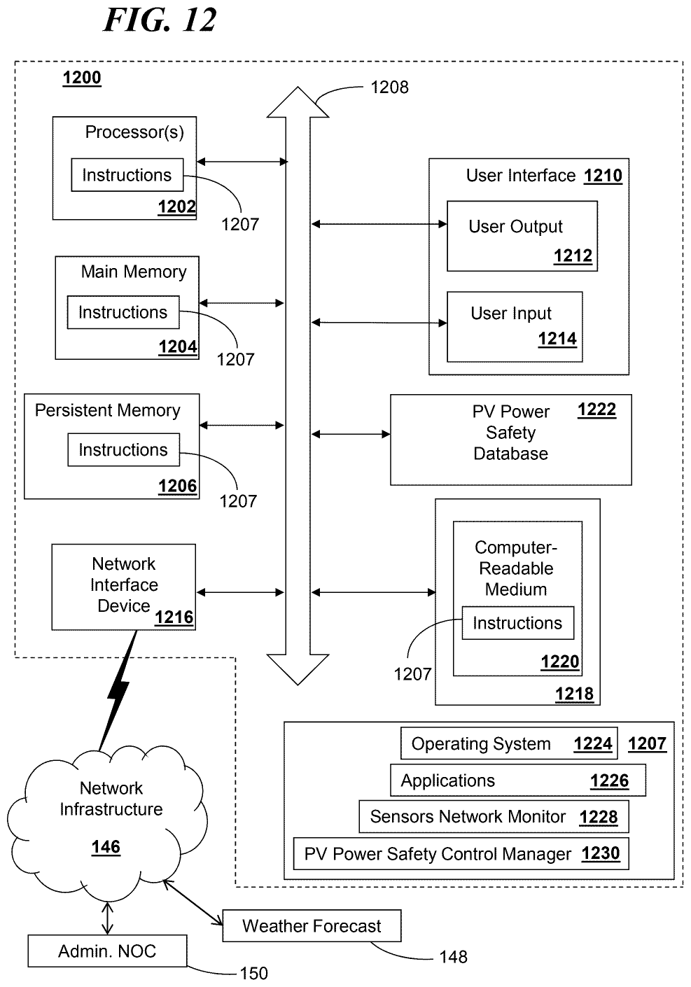

The processor (also referred to as computer processor) 1202 (see FIG. 12) of the photovoltaic power plant safety controller 140 can communicate (e.g., via computer network and/or link) with the solar panel controller of each solar panel. The communication path is indicated by connector A 142 for receiving input (e.g., messages, responses, and/or data) from the solar panel controller to the photovoltaic power plant safety controller 140. Connector B 144 indicates transmitting output (e.g., messages, commands/instructions, and/or data) from the photovoltaic power plant safety controller 140 to the solar panel controller.

Each combiner box 120, 122, includes a combiner box controller (not shown). The photovoltaic power plant safety controller 140 can communicate (e.g., via computer network and/or link) with the combiner box controller of each combiner box 120, 122. The communication path is indicated by connector A 142 for receiving input (e.g., messages, responses, and/or data) from the combiner box controller to the photovoltaic power plant safety controller 140. Connector r B 144 indicates transmitting output (e.g., messages, commands/instructions, and/or data) from the photovoltaic power plant safety controller 140 to the combiner box controller.

The inverter 124 includes an inverter controller (not shown). The photovoltaic power plant safety controller 140 can communicate (e.g., via computer network and/or link) with the inverter controller of the inverter 124. The communication path is indicated by connector A 142 for receiving input (e.g., messages, responses, and/or data) from the inverter controller to the photovoltaic power plant safety controller 140. Connector B 144 indicates transmitting output (e.g., messages, commands/instructions, and/or data) from the photovoltaic power plant safety controller 140 to the inverter controller.

The photovoltaic power plant safety controller 140 is communicatively coupled to a communications network (also referred to as a wide area computer network) 146. The communications network 146 can include any one or more of a communications link, a wireless network, wired network, local area network, wide area network, or the Internet. Through the communications network 146, the photovoltaic power plant safety controller 140 communicates with an administrative network operation control processing system (NOC) 150. The NOC 150 monitors the operations of the photovoltaic power plant safety controller 140, and the other controllers, and collects data from the solar panel controller(s), the combiner box controller(s), the inverter controller, and the photovoltaic power plant safety controller 140. Solar power generator system technicians and other administrative personnel can interface with the NOC 150, via a user interface, and thereby monitor operations of, and capture data from, the various controllers in the solar power generation system 102.

The NOC 150 can transmit commands, instructions which may include software instructions, and/or data which may include configuration parameters and other data, to the photovoltaic power plant safety controller 140. The commands, instructions, and data can be further transmitted from the photovoltaic power plant safety controller 140 to the various other controllers in the solar power generation system 102.

The photovoltaic power plant safety controller 140, according to various embodiments, can communicate via the network 146 with a weather forecast source 148 such as provided by a remote server. The weather forecast source 148, for example, can comprise a weather service computer server communicatively coupled to the Internet. The photovoltaic power plant safety controller 140 can receive information from the remote weather service server 148 that indicates weather and/or ambient conditions in a geographic location of the solar farm (solar array field). The received information can indicate current weather (and ambient) conditions generally in the solar farm as well as forecasted weather and ambient conditions that will affect the solar farm's geographic area within a short amount of time (e.g., several hours or possibly the next day). The received information can include any one or more of the following conditions: temperature, level of solar irradiance, atmospheric weather, humidity, wind conditions, cloud cover conditions, time of day associated with any of the previously mentioned conditions, and other related weather data.

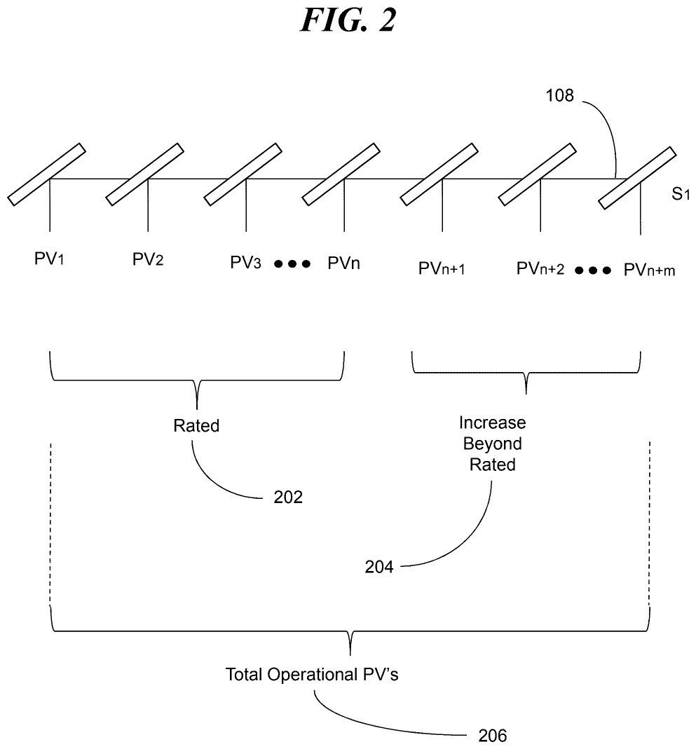

FIG. 2 illustrates one example of PV's (also referred to as photovoltaic panels, tracker solar panels, or solar panels, or the like) in the first string 108 shown in FIG. 1. In this example, a first group 202 of operational solar panels (e.g., solar panels 1 to 28, or more) in the first string 108 will generate a variable DC voltage at the output 109 of the first string 108 that under extreme weather and ambient conditions (i.e., all anticipated weather and ambient conditions) remains within the industry-rated maximum DC voltage for safe operation of the inverter 124, as well as safe operations of the combiner box 120 and the electrical components in between the string output 109 and the input 125 of the inverter 124.

The power generation industry provides a standard rating for the maximum DC voltage (e.g. based on an open circuit voltage V_{oc}) allowed at the input 125 into the inverter 124, and similarly allowed at all the electrical components from the output 109 of each of the strings of solar panels to the input 125 into the inverter 124. The power industry has continued to increase the maximum DC voltage over the years; changing from 600 V DC, to 1000 V DC, and now to 1500 V DC. The industry is anticipating that standard rating to be further increased in the future to 2000 V DC.

The string size is limited by the maximum DC voltage rating of a power generation system, e.g., 1500 V DC (e.g. based on an open circuit voltage V_{oc} allowed at the input 125 into the inverter 124). For example, the maximum number of operational solar panels in a string to operate below a highest solar panel open-circuit voltage (V_{oc}) threshold (e.g., within the industry-rated maximum DC voltage, such as 1500 V DC), can be calculated in accordance with industry standard NEC 690.7. Additionally, the Institute of Electrical and Electronics Engineers (IEEE) published guidelines for solar panel string sizing (maximum total number of operational solar panels in a string) using site-specific modeling and data. The power generation industry has traditionally calculated maximum string size solely based on historical extremely low (e.g., lowest) temperature condition (e.g., −20 degrees Centigrade or lower) and with assumed full irradiance condition (e.g., 1000 w/m² or higher) (i.e., extreme irradiance or highest irradiance) at that extremely low temperature, and with an open circuit at the output of the inverter 124 (e.g. based on an open circuit voltage V_{oc} allowed at the input 125 into the inverter 124). Under the extreme weather and/or ambient conditions described above the industry calculates (and rates) the maximum number of operational solar panels allowed in a string (e.g., PV₁ to PVₙ) while keeping output DC voltage from the string no greater than the industry standard rated threshold maximum DC voltage, currently 1500 V DC. The industry standard rated threshold maximum DC voltage of currently 1500 V DC, also sets an industry standard rated maximum number of operational solar panels allowed in a string, which is calculated for a specific environment (site) by industry standard methods such as industry standard NEC 690.7 and based on guidelines published by the IEEE. Only as an example, and not for limitation, say the rated total maximum number of operational PV's is twenty eight (28).

A first example method for calculating and designing in a string the rated total number of operational PV's (i.e., the first group 202 PV₁ to PVₙ), includes:
1.0 Get STC (Standard Test Condition) V_{oc} from datasheet provided by the manufacturer of the solar module;
2.0 Get the temperature coefficient of V_{oc} provided by the manufacturer of the solar module;
3.0 Get lowest temperature of the solar farm project site in last May 10, 2020 /50 years (the exact number varies with the engineer of record designing the solar project, but 20 years is the most common time period used);
4.0 Using the above information, find the adjusted maximum V_{oc} of the PV module (incorporating historical lowest temperature);
5.0 Rated maximum string size equals round-down (rated maximum inverter voltage/maximum adjusted V_{oc} of the PV module).

It should be noted that STC is a very specific condition. For example, and not for limitation, STC can include a solar module temperature 25 C, and irradiance 1000 W/m². However, usually a realistic condition can be different than STC. The inventors have established that a change in temperature changes the V_{oc}. The inventors have found that one can use the V_{oc}at STC and the temperature coefficient of V_{oc} to find what would be the actual V_{oc} for any weather condition (referred to as the adjusted V_{oc}). The adjusted V_{oc} is also experienced at the input 125 of the inverter 124.

A second example method for calculating and designing in a string the rated total number of operational PV's (i.e., the first group 202 PV₁ to PVₙ), includes:
1.0 Get STC (Standard Test Condition) V_{oc} from datasheet provided by the manufacturer of the solar module;
2.0 Get the temperature coefficient of V_{oc} provided by the manufacturer of the solar module
3.0 Find the irradiance relation with V_{oc} provided by the manufacturer of the solar module;
4.0 Get historical weather data for the solar farm project site (typically for at least 20 years history);
5.0 Using the historical weather data, find the V_{oc} of the PV module at every weather data points (incorporating historical temperature and irradiance), which are the V_{oc} data points;
6.0 Find the maximum V_{oc} of the PV module from all the V_{oc} data points; and
7.0 Rated maximum string size equals round-down (rated maximum inverter voltage/maximum V_{oc} of the PV module).

Continuing with reference to FIG. 2, a second group 204 of solar panels in the first string 108 includes one or more operational solar panels (e.g., PVₙ₊₁ to PVₙ₊ₘ). Only as an example, and not for limitation, the increase total number of operational PV's is two (2) beyond the rated total number of operational PV's which in this example total is twenty eight (28). The design of the string 108 comprising a total number of operational PVs 206 (including the first group 202 PV₁ to PVₙ, and the second group 204 PVₙ₊₁ to PVₙ₊ₘ), in this example is thirty (30), such that it will generate a DC voltage at the output 109 of the first string 108 that during non-extreme weather and ambient conditions is calculated to remain most of the time during the year within the industry-rated maximum DC voltage threshold (e.g., 1500 V DC) while not causing an overvoltage condition at the input 125 into the inverter 124. However, during extreme weather and ambient conditions, the DC voltage at the output 109 can create an over-voltage condition at the input 125 of the inverter 124 that could exceed the industry-rated maximum DC voltage threshold (e.g., 1500 V DC) at the input 125 for the safe operation of the inverter 124, as well as exceed the safe operation of the combiner box 120 and the electrical components in between the string output 109 and the input 125 of the inverter 124.

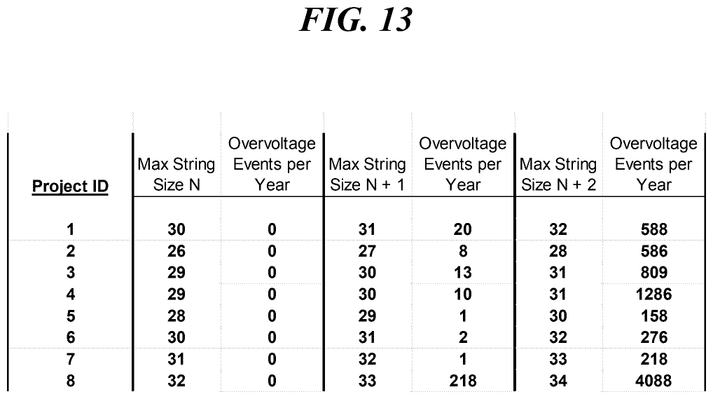

FIG. 13 is a table that lists eight example projects (by rows in the table) having three different maximum string sizes (e.g., N, N+1, N+2). Each maximum string size for a project is associated with a number of overvoltage events per year. The rated total maximum number of PV's in a string results in zero overvoltage events per year. This is shown for each project in the left-most column with a maximum string size of N. As one PV (middle column) and then two PV's (right-most column) are added to the string, the total number of PV's in the string is higher than the rated total maximum number of PV's (left-most column). Each higher number of total PV's in a string results in a higher number of overvoltage events per year. The lower the number of overvoltage events per year for a string results in a lower number of times during the year that a safety operation would have to be taken by the photovoltaic power plant safety controller 140 to prevent the overvoltage event from causing damage to the equipment in the solar array field, the one or more combiner boxes, and the inverter equipment.

For example, for project number one with a maximum string size of N+1, there are twenty overvoltage events per year. However, with a maximum string size of N+2, there are 588 overvoltage events per year. As a second example, for project number 8, a maximum string size of N+1, results in 218 overvoltage events per year. However, for a maximum string size of N+2, there are 4088 overvoltage events per year. Each photovoltaic power generating plant site has a specific operating environment which is susceptible to inclement weather or other ambient conditions in the solar array field. A photovoltaic power generating plant designer would have to determine a maximum string size, beyond the rated maximum string size, that would be most suitable for maintaining safe operations during the year.

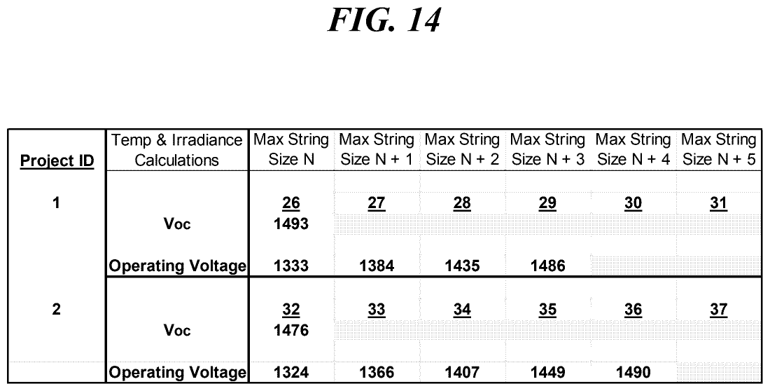

FIG. 14 is a table that lists two example projects (by rows in the table) having six different maximum string sizes (e.g., N, N+1, N+2, . . . , N+5). Each maximum string size (i.e., each column) for a project is associated with an open circuit voltage and a lower operating voltage. The open circuit voltage shows at what total maximum number of PV's (total maximum string size) the open circuit voltage is at or below the rated maximum DC voltage. In this example, the rated maximum DC voltage is 1500 V DC. For project 1, the maximum open circuit voltage (1493 Volts DC) that is rated safe and operational (at or below 1500 V DC) for a string is a maximum size of 26 PV's. Note that the operating voltage for the string when not in an open circuit condition is 1333 volts. Increasing the total number of PV's (increasing the string size) beyond the rated maximum string size of N (i.e., 26 PV's), will not tolerate an increase in open circuit voltage condition, because it increases above the rated maximum voltage (e.g., 1500 V DC). However, operating voltages for the string sizes N+1, N+2, and N+3 (total 29 PV's) will remain most of the time at or below the rated maximum voltage (e.g., 1500 V DC). Therefore, for example, a designer might chose to set an operating voltage maximum string size as high as twenty nine PV's in a string. However, whenever the photovoltaic power plant safety controller 140 determines that the system 102 will go into, or is in, an open circuit voltage condition, the solar stowing and shunt load (shunt resistance) will activate to reduce the voltage at the input 125 of the inverter 124 below the rated maximum system voltage level (e.g., 1500 V DC).

A similar analysis of the second project in the table shows that the operating voltages for the string sizes N+1, N+2, N+3, N+4 (total 36 PV's in a string) will remain most of the time at or below the rated maximum voltage (e.g., 1500 V DC). Therefore, for example, a designer might choose to set an operating voltage maximum string size as high as thirty six PV's in a string. However, whenever the photovoltaic power plant safety controller 140 determines that the system 102 will go into, or is in, an open circuit voltage condition, the solar stowing and shunt load (shunt resistance) will activate to reduce the voltage at the input 125 of the inverter 124 below the rated maximum system voltage level (e.g., 1500 V DC).

Below will be discussed a new and novel method for calculating and designing in a string the total maximum number of operational PV's 206 that is greater than the rated total maximum number of PV's (i.e., including the first group 202 PV₁ to PVₙ, and the second group 204 PVₙ₊₁ to PVₙ₊ₘ).
1.0 Get the rated total maximum string size using current industry practice;
2.0 Get STC (Standard Test Condition) operating voltage from datasheet provided by the manufacturer of the solar module;
3.0 Get the temperature coefficient of operating voltage provided by the manufacturer of the solar module;
4.0 Find the irradiance relation with operating voltage provided by the manufacturer of the solar module;
5.0 Get historical weather data for the solar farm project site (typically for at least 20 years history);
6.0 Using the historical weather data, find the operating voltage at every one of the weather data points (incorporating historical temperature and irradiance) that are not identified as extreme operating conditions as specified under industry practice; which are the operating voltage data points;
7.0 Find the maximum operating voltage of the PV module from all the operating voltage data points;
8.0 The total maximum number of operational PV's that can be added to the rated total maximum string size is equal to [round-down (the rated maximum inverter voltage/the maximum operating voltage of the PV module)]−[rated total maximum string size].

Using this new and novel method for setting the total maximum number of operational PV's, whenever the photovoltaic power plant safety controller 140 determines that the system 102 will go into, or is in, an open circuit voltage condition, the solar stowing and shunt load (shunt resistance) will activate to reduce the voltage at the input 125 of the inverter 124 below the rated maximum system voltage level (e.g., 1500 V DC).

The photovoltaic power plant safety controller 140, according to various embodiments of the present invention, interoperates with the other controllers in the system 102 to maintain the safe operation of the inverter 124, and safe operation of all the electrical components in between the string outputs 109 and the input 125 of the inverter 124. The following discussion will present, by several examples, technical solutions to maintain the safe operation of solar power generation system 102 under all weather and ambient conditions, while operating at least under non-extreme conditions most of the time during a year a total number of operational solar panels 206 (in the example of FIG. 2, thirty solar panels) in a string which is greater than the industry-rated maximum number of operational solar panels (in the example of FIG. 2, twenty-eight operational solar panels in a string).

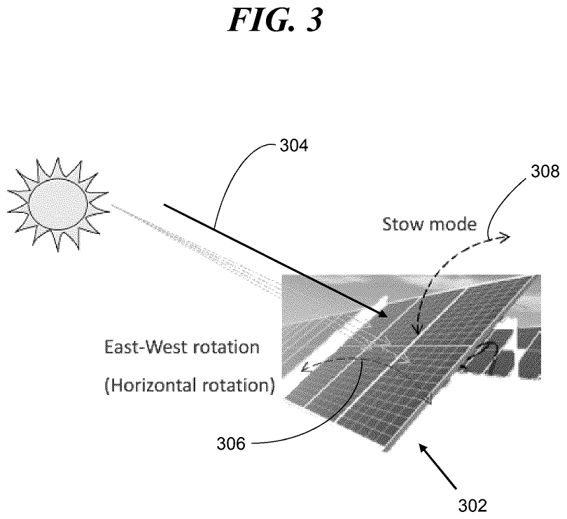

FIG. 3 illustrates the operations of an example tracker solar panel 302 according to certain embodiments of the present invention. The tracker solar panel 302 moves (rotates) from East to West 306 during the day tracking the movement of the sun. The tracker solar panel 302, under control from its solar panel controller, continuously aims its photovoltaic cells to receive sunlight directly in a generally straight line 304 from the sun.

The solar panel controller can cause solar panel 302 to tilt at a solar stow angle (to a solar stow tilt position) 308 away from a straight-line 304 of sunlight from the sun, in response to receiving a solar stow command from the photovoltaic power plant safety controller 140. The solar panel 302, at the solar stow angle, no longer tracks the direction 304 of sunlight from the sun. This solar stow mode of operation (to a solar stow position) 308, and by stopping the tracking solar panel from tracking the direction of sunlight from the sun (a stationary position), can effectively reduce, or remove, the voltage/current output from the particular solar panel 302, and accordingly reduces the total output voltage at the output 109 of the string 108. According to various embodiments, the solar stow position directs the tracking solar panel 302 to face a direction that avoids pointing toward direct sunlight from the sun at sunrise. According to various embodiments, the solar stow tilt position can coincide with an inclement weather stow tilt position.

It should be noted that the solar stow position is a different mode of operation from an inclement weather stow position. Tracking solar panels can be controlled to tilt to an inclement weather stow position in preparation of an imminent storm with flying projectiles which can damage or destroy the tracking solar panel if continuing to attempt to track sunlight from the sun during the storm. The solar stow position, very different from the inclement stow position, is intended to avoid sunlight from the sun reaching the solar cells of the solar panel to reduce solar power generated from the tracking solar panel. In certain embodiments, the direction of the solar stow position might substantially coincide with the direction of the inclement weather stow position. However, the operations of the two separate modes of operation of a tracking solar panel are very different.

The solar panel controller, alternatively, can cause the solar panel 302 to tilt toward and track a straight line of sunlight from the sun, in response to receiving a solar track command from the photovoltaic power plant safety controller 140. The solar panel 302 then continuously tracks the direction 304 of sunlight from the sun. That is, the solar panel while in a solar stow angle (solar stow mode of operation 308) will respond to the solar track command from the photovoltaic power plant safety controller 140 by returning to tracking the direction 304 of sunlight from the sun.

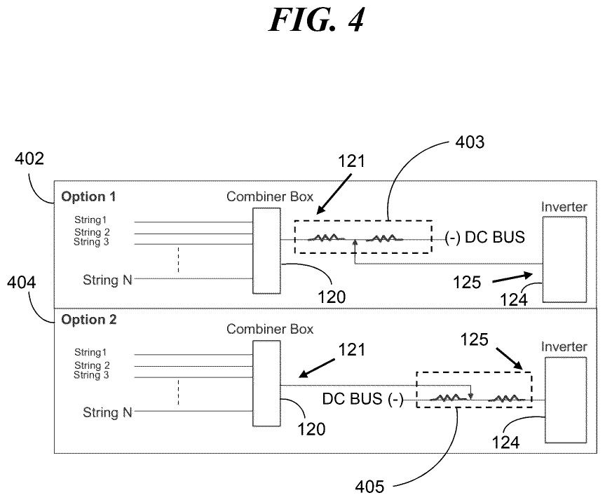

Continuing with reference to FIG. 4 and FIG. 1, a first example 402 of a controllable safety shunt load (e.g., shunt resistance) 403 is shown at output 121 of the combiner box 120. A second example 404 of a controllable safety shunt load (e.g., shunt resistance) 405 is shown at the input 125 of the inverter 124.

In the first example 402, safety shunt load (e.g., shunt resistance) circuit 403 is controlled by the combiner box controller in the combiner box 120. Additionally, a DC voltage at each output 121, 123, of the combiner boxes 120, 122, can be sensed and monitored by the respective combiner box controller of the combiner boxes 120, 122. In the second example 404, the safety shunt load (e.g., shunt resistance) circuit 405 is controlled by the inverter controller in the inverter 124. Additionally, a DC voltage at the input 125 of the inverter 124 can be sensed and monitored by the inverter controller of the inverter 124.

Each safety shunt load (e.g., shunt resistance) circuit 403, 405, can be selectively switched in or switched out of, the electrical interconnection circuit between the output 121 of the first combiner box 120 and the input 125 of the inverter 124. When switched in the safety shunt load (e.g., shunt resistance) circuit 403 at the output 121 of the first combiner box 128 reduces the output DC voltage to within the rated maximum DC voltage threshold (e.g., maximum 1500 V DC) at the output 121 of the first combiner box 128. When the safety shunt load (e.g., shunt resistance) circuit 403 is switched out, the output DC voltage at the output 121 is the combined output voltage of all the strings 108, 110, 112, which are input to the first combiner box 120. It should be noted that a safety shunt load (e.g., shunt resistance) circuit 403 would similarly operate at the output 123 of the second combiner box 122. When the safety shunt load (e.g., shunt resistance) circuit 403 is switched out, however, in this alternative circuit arrangement the output DC voltage at the output 123 would be the combined output voltage of all the strings 114, 116, 118, which are input to the second combiner box 122.

In the second example 404, when the safety shunt load (e.g., shunt resistance) circuit 405 is switched in at the input 125 of the inverter 124, the combined output DC voltage of the two combiner boxes 120, 122, is reduced to within the rated maximum DC voltage threshold (e.g., maximum 1500 V DC). When the safety shunt load (e.g., shunt resistance) circuit 405 is switched out, however, the combined output DC voltage of the two combiner boxes 120, 122, will be the input DC voltage at the input 125 of the inverter 124.

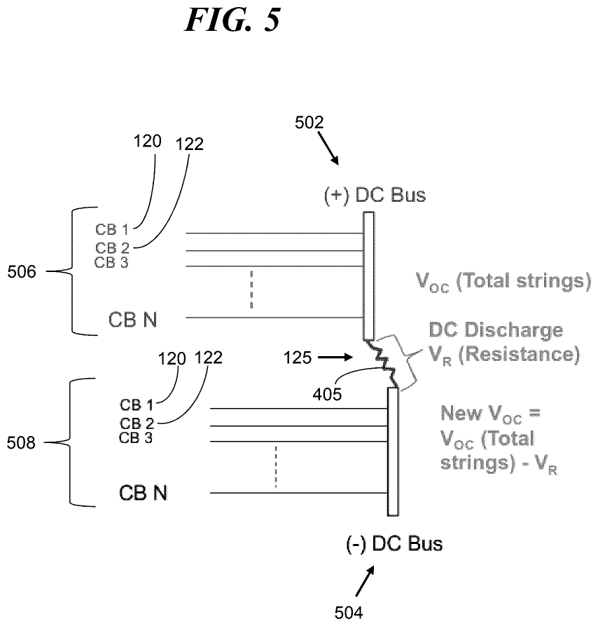

A more detailed view of the second example is shown in FIG. 5. The output DC voltage of each of the combiner boxes 120, 122, is developed between a positive DC voltage output and a negative DC voltage return input. That is, each output 121, 123, has a positive DC voltage output paired with a negative DC voltage return input. The positive DC voltage output line from each output 121, 123, is electrically connected to a positive DC bus 502 at the input 125 of the inverter 124. The negative DC voltage return line of each output 121, 123, is connected to a negative DC bus 504 at the input 125 of the inverter 124. FIG. 5 is generalized to illustrate a larger number of combiner boxes (e.g., N combiner boxes), with positive DC voltage output lines 506 from each of the combiner boxes electrically connected to the positive DC bus 502 and negative DC voltage return lines 508 to each of the combiner boxes electrically connected to the negative DC bus 504.

FIG. 5 shows the safety shunt load (e.g., shunt resistance) circuit 405 switched in at the input 125 of the inverter 124. The safety shunt load (e.g., shunt resistance) circuit 405 creates a DC voltage discharge path through a shunt DC discharge resistance between the positive DC bus 502 and the negative DC bus 504. A combined open circuit voltage V_{oc}, which is the combined output DC voltage of the combiner boxes 120, 122, and accordingly the combined DC voltage of all of the strings, is reduced by the voltage (V_{R}) developed across the switched in shunt DC discharge resistance. The new combined open circuit voltage V_{oc} will be reduced, according to the example, to within the rated maximum DC voltage threshold (e.g., maximum 1500 V DC) at the input 125 of the inverter 124.

It should be noted that, according to various embodiments, a safety shunt load (e.g., shunt resistance) circuit 403 at the output of one or more of the combiner boxes can be selectively switched in or out, or a safety shunt load (e.g., shunt resistance) circuit 405 can be selectively switched in or out at the input 125 of the inverter 124, or a combination of both the safety shunt load (e.g., shunt resistance) circuit 403 at the output of one or more of the combiner boxes and a safety shunt load (e.g., shunt resistance) circuit 405 at the input of the inverter can both be selectively switched in or out, to effectively reduce the DC voltage at the input 125 of the inverter 124 and at the output of each of the combiner boxes 120, 122 to below the rated maximum DC voltage threshold (e.g., maximum 1500 V DC).

In some embodiments, a safety shunt load (e.g., shunt resistance) circuit can be located, and selectively switched in or out, at the output 109 of each of the strings 108, 110, 112, 114, 116, 118. The output 109 of the first string 108 is also an input into the first combiner box 120. Therefore, a voltage can be sensed and monitored at each output 109 of the strings, which is also the voltage at each string input combined into its respective combiner box 120, 122.

Additionally, according to various embodiments, a solar panel by-pass switch and safety shunt load (e.g., shunt resistance) circuit (not shown) can be located between the collective output of the second group 204 of solar panels (as shown in the example of FIG. 2) and the collective input of the first group 202 of solar panels. The solar panel by-pass switch and safety shunt load (e.g., shunt resistance) circuit can be controlled by a solar panel controller, in the example of FIG. 2, located in solar panel 28 (in the first group 202) or solar panel 29 (in the second group 204). The photovoltaic power plant safety controller 140 can communicate with the particular solar panel controller to control the solar panel by-pass switch and safety shunt load (e.g., shunt resistance) circuit.

The solar panel by-pass switch and safety shunt load (e.g., shunt resistance) circuit can be selectively switched in, by control from the photovoltaic power plant safety controller 140, to electrically remove from the string 108 the collective output voltage of the second group 204 of solar panels while at the same time switching in a safety shunt load (e.g., shunt resistance) circuit at the output of the second group 204 of solar panels to allow a safe discharge of voltage at the output through a discharge resistance. This effectively reduces the number of operational solar panels in the first string 108 to only those in the first group 202. Recall this first group 202 provides an output voltage within a rated maximum output voltage threshold during extreme weather and/or ambient conditions. That is, the first group 202 will provide an output voltage that does not exceed the industry-rated maximum DC voltage threshold for the particular solar farm (solar array field) during all anticipated conditions including during extreme weather and/or ambient conditions.

Alternatively, the solar panel by-pass switch and safety shunt load (e.g., shunt resistance) circuit can be selectively switched out, by control from the photovoltaic power plant safety controller 140. In response, the first string 108 comprises a total number of operational solar panels 206 which includes the first group 202 and the second group 204. In the example of FIG. 2, total number of operational solar panels 206 is thirty solar panels in the first string 108, which is greater than the industry-rated maximum number of solar panels (in the example of FIG. 2, twenty-eight solar panels in a string).

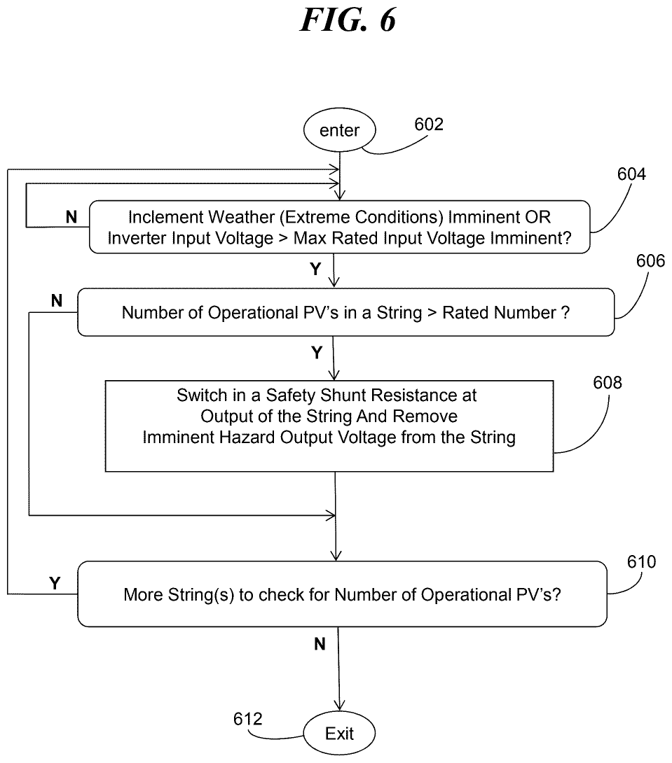

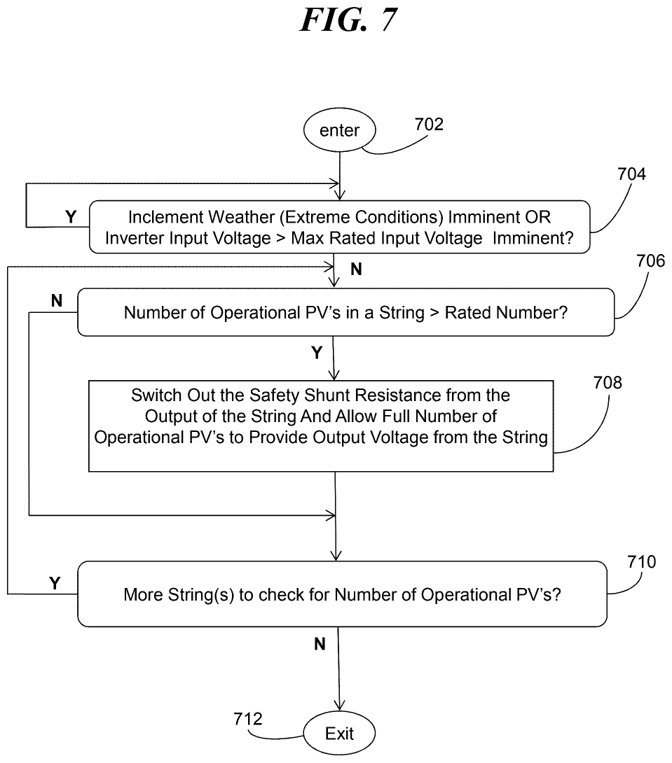

FIGS. 6 and 7 illustrate a first example set of operations of system 102 according to various embodiments. In this example, each string can include either greater number of PV's than the rated total maximum string size or not. A safety shunt load is switched in or out at the output of the string, as necessary to protect the system from over-voltage condition or alternatively to maximize power output from the string. Starting with FIG. 6, a processor 1202 (see FIG. 12, and associated description below) in the PV power plant safety controller 140 enters the operational sequence, at step 602, and immediately proceeds to check, at step 604, if inclement weather is imminent (i.e., extreme conditions are imminent) or if an input voltage at the inverter greater than the maximum rated input DC voltage threshold is imminent. In the present examples of operations of the system 102, the terms “extreme conditions”, “extreme weather and/or ambient conditions”, or the like, are intended to mean any one or more of the following conditions: a) solar irradiance in proximity to a solar cell in a tracking solar panel in one of the strings in a tracking solar field is at or above a highest historical solar irradiance (e.g., 800 W/m² or higher); b) temperature of a solar cell in a tracking solar panel in one of the strings is at or below a lowest historical temperature of a solar cell in the tracking solar array field (e.g., −10 degrees Centigrade or lower); c) ambient temperature in proximity to one of the tracking solar panels in one of the strings is at or below a lowest historical ambient temperature in the tracking solar array field (e.g., −10 degrees Centigrade or lower); or d) any combination of at least two of a), b), or c).

The processor 1202 in the PV power plant safety controller 140 transmits a request message (a query) to the weather forecast source (server) 148 requesting (querying) information indicating the current, and the imminent, weather and/or ambient conditions at the solar farm. The imminent conditions, which can include extreme conditions, are predicted to occur at the solar farm (solar array field) within a short amount of time, such as within several hours during a day or possibly the next day. In response, the server 148 transmits one or more messages to the processor 1202 which include the requested information about the current, and the imminent, weather and/or ambient conditions, which can be extreme operating conditions in the solar array field.

The processor 1202, interoperating with a sensors network monitor 1228 (see FIG. 12), can also monitor sensors in the solar farm, such as at one or more of the solar panels in the solar farm (solar array field), to determine current weather and/or ambient conditions. In some embodiments, the processor 1202 maintains a history database 1222 of information about past weather and/or ambient conditions at the solar farm. The processor 1202, interoperating with a weather and ambient conditions analyzer application 1226, can analyze the above-described information to determine if the current, and imminent, weather and/or ambient conditions are extreme conditions. Extreme conditions can affect photovoltaic cells and solar panels causing them to generate high levels of output DC voltage that create an over-voltage safety concern for the inverter 124 and all electrical components in between the output 109 of the string 108 of solar panels and the input of inverter 124. In the present examples of operations of the system 102, the terms “extreme conditions”, “extreme weather and/or ambient conditions”, or the like, are intended to mean any one or more of the following conditions: a) solar irradiance in proximity to a solar cell in a tracking solar panel in one of the strings in a tracking solar field is at or above a highest historical solar irradiance (e.g., 800 W/m² or higher); b) temperature of a solar cell in a tracking solar panel in one of the strings is at or below a lowest historical temperature of a solar cell in the tracking solar array field (e.g., −10 degrees Centigrade or lower); c) ambient temperature in proximity to one of the tracking solar panels in one of the strings is at or below a lowest historical ambient temperature in the tracking solar array field (e.g., −10 degrees Centigrade or lower); or d) any combination of at least two of a), b), or c).

If processor 1202, according to the example, determines from the information that extreme conditions are not imminent then processor 1202 continues checking, at step 604. However, if extreme conditions are imminent the processor 1202, at step 606, determines if the number of operational solar panels in each string is greater than the industry-rated maximum number of solar panels.

If processor 1202, at step 606, determines that the number of operational solar panels in a string is greater than the rated maximum number, the processor 1202, at step 608, according to the example, transmits command(s) to a string solar panel controller, for example, and in response the string solar panel controller selectively switches in a safety shunt load (e.g., shunt resistance) circuit at the output 109 of the string 108. This electrically removes imminent hazard output voltage from the output 109 of the string 108. The safety shunt load (e.g., shunt resistance) circuit at the output 109 of the string 108 of solar panels allows a safe discharge of voltage at the output through a discharge load (e.g. discharge resistance) circuit. This effectively reduces the output voltage from the string 108 to within a rated maximum output voltage threshold (e.g., 1500 V DC) during imminent extreme weather and/or ambient conditions.

Processor 1202, at step 610, determines if there are more strings to check for the number of operational solar panels, and if so the operational sequence returns to step 604. If there are no more strings to check, at step 610, then the processor 1202 exits the operational sequence, at step 612.

Referring to FIG. 7, processor 1202 enters the operational sequence, at step 702, and immediately proceeds to check, at step 704, if inclement weather is (extreme conditions are) imminent or if an input voltage at the inverter greater than the maximum rated input DC voltage threshold is imminent. If extreme conditions are not imminent, and/or ceased to be imminent, and input voltage at the inverter greater than the maximum is not imminent, then, at step 706, the processor 1202 determines whether the number of operational solar panels in a string is greater than the rated maximum number of solar panels.

If not greater in the current string, at step 706, the processor 1202 determines, at step 710, if there are more strings to check for the total number of operational PV's. If the processor 1202, at step 706, determines that the current string includes more than the rated total maximum number of operational solar panels, the processor 1202, at step 708, transmits a command to a string solar panel controller, which in response selectively switches out the safety shunt load (e.g., shunt resistance) circuit at the output 109 of the string 108. Therefore, the string 108 output voltage is the collective voltage from the full string of operational PV's.

For example, with reference to FIG. 2, the total number of operational solar panels 206 would provide output voltage at the output of the string, which includes the first group 202 and the second group 204. In the example of FIG. 2, the total number of operational solar panels 206 is thirty solar panels, which is greater than the industry-rated maximum number of solar panels (in the example of FIG. 2, twenty-eight solar panels in a string).

This operational sequence repeats, at step 710, as long as there are more strings to check for number of operational solar panels. If there are no more to check, at step 710 then the processor 1202 exits the operational sequence, at step 712.

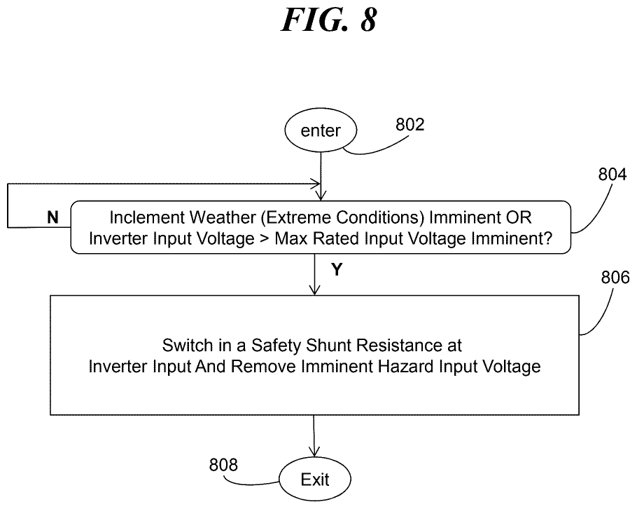

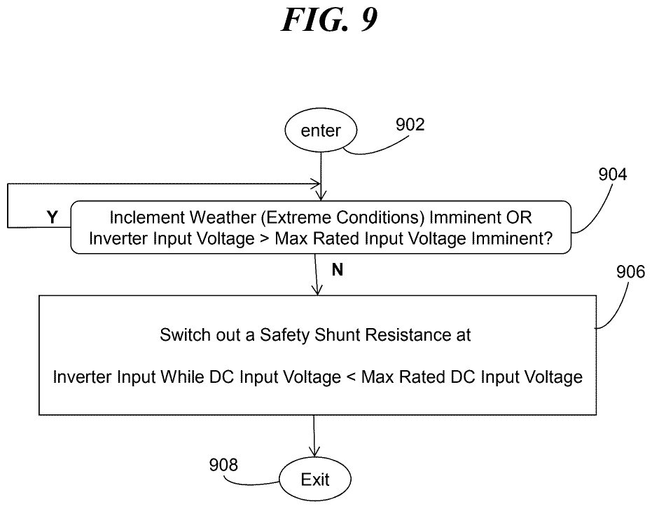

FIGS. 8 and 9 illustrate a second example set of operations of system 102 according to various embodiments. In this example, a safety shunt load (e.g., shunt resistance) circuit is selectively switched in at the output of one or more combiners, at the input 125 of the inverter 124, or both, to electrically remove imminent hazard input voltage at the input of the inverter 124. Alternatively, the safety shunt load (e.g., shunt resistance) circuit is selectively switched out to allow maximum input voltage at the input 125 of the inverter 124. Referring to FIG. 8, the processor 1202 enters, at step 802, and immediately proceeds to check, at step 804, if inclement weather is (extreme conditions are) imminent or if an input voltage at the inverter greater than the maximum rated input DC voltage threshold is imminent. If imminent then the processor 1202, at step 806, switches in a safety shunt load (e.g., shunt resistance) circuit at the output 121, 123, of one or more combiners 120, 122, at the input 125 of the inverter 124, or both, to remove imminent hazard voltage at the input 125 of the inverter 124. Processor 1202, at step 808, then exits the operational sequence.

Referring to FIG. 9, the processor 1202 enters the operational sequence, at step 902, and immediately proceeds to check, at step 904, if inclement weather is (extreme conditions are) not imminent, and/or ceased to be imminent, and if an input voltage at the inverter greater than the maximum rated input DC voltage threshold is not imminent. If both conditions are not imminent then, at step 906, the processor 1202 switches out a safety shunt load (e.g., shunt resistance) circuit at the output 121, 123, of one or more combiners 120, 122, at the input 125 of the inverter 124, or both, to allow maximum input voltage at the input 125 of the inverter 124. Processor 1202, at step 908, then exits the operational sequence.

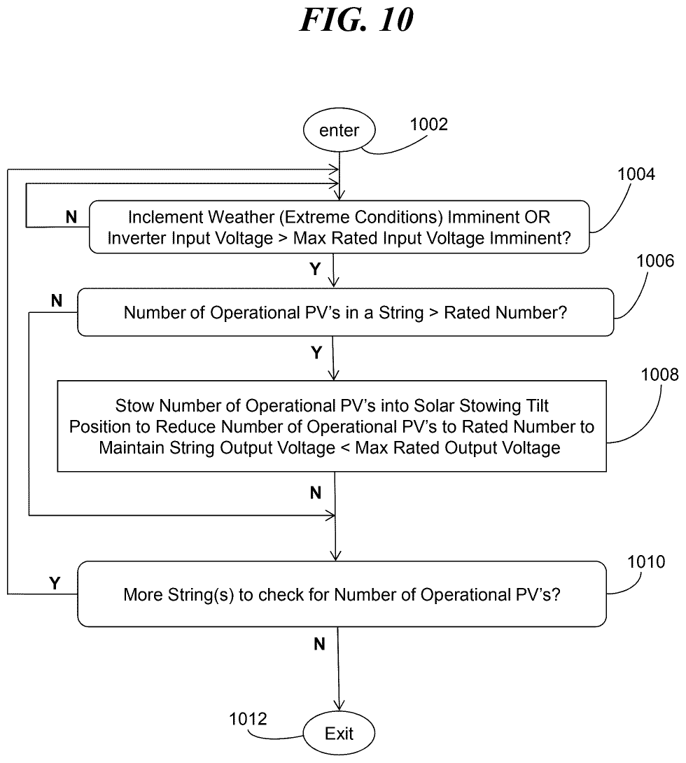

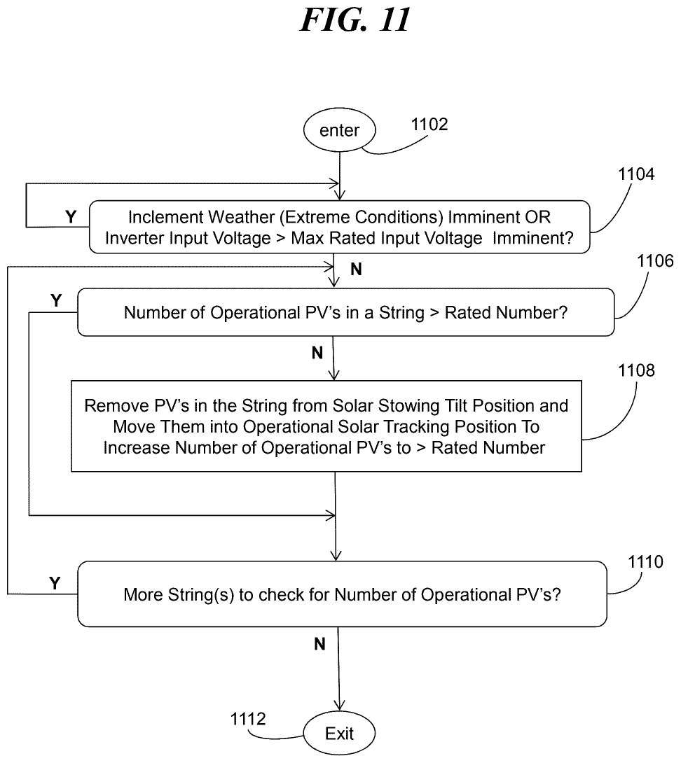

FIGS. 10 and 11 illustrate a third example set of operations of system 102 according to various embodiments. In this example, PV's can be selectively moved into a solar stow tilt position or moved out of the solar stow tilt position and back into an operational solar tracking position. Referring to FIG. 10, the processor 1202 enters the operational sequence, at step 1002, and immediately proceeds to check, at step 1004, if inclement weather is (extreme conditions are) imminent or if an input voltage at the inverter greater than the maximum rated input DC voltage threshold is imminent. If either condition is imminent then, at step 1006, the processor 1202 determines if the number of operational solar panels in a string is greater than the industry-rated maximum number of solar panels.

If processor 1202, at step 1006, determines that the number of operational solar panels is greater than the rated maximum number, the processor 1202, at step 1008, transmits commands to a string solar panel controller, and in response the string solar panel controller sends commands to one or more PV's (at least a subset of the operating tracking solar panels) in the string to perform a solar stow tilt and move into a solar stow tilt position. This reduces the number of operational solar panels in the string 108 to within the rated maximum number of solar panels (in the example of FIG. 2, it would be twenty-eight solar panels).

The processor 1202, at step 1010, determines if there are more strings to check for the number of operational solar panels, and if there is/are more string(s) to check the operational sequence returns to step 1004. If there are no more strings to check, at step 1010, then the processor 1202 exits the operational sequence, at step 1012.

Referring to FIG. 11, the processor 1202 enters the operational sequence, at step 1102, and immediately proceeds to check, at step 1104, if inclement weather is (extreme conditions are) imminent or if an input voltage at the inverter greater than the maximum rated input DC voltage threshold is imminent. If both conditions are not imminent (i.e., extreme conditions are not imminent, and/or ceased to be imminent, and input voltage at the inverter greater than the maximum is not imminent) then, at step 1106, the processor 1202 determines whether the number of operational solar panels in a string is greater than the rated total maximum number of solar panels.

If not greater, at step 1108, processor 1202 instructs one or more of the solar panels, which in the example of FIG. 2 would be the second group 204, to change from the solar stowing tilt position to the operational solar tracking position and mode of operation, which increases, by the at least a subset of the operational tracking solar panels, the total number of operational solar panels to greater than the rated total maximum number of solar panels in the string 108. In the example of FIG. 2, the total number of operational solar panels would be thirty solar panels, which is greater than the rated total maximum number of operational solar panels, which in the example of FIG. 2 would be twenty eight solar panels. Therefore, the string 108 output voltage would be the collective voltage from the full string of operational PV's. In the example of FIG. 2, this would be the total number of operational solar panels 206 which includes the first group 202 and the second group 204. In the example of FIG. 2, this total 206 would be thirty solar panels in a string (greater than the total number of twenty-eight which is the rated total maximum number of solar panels).

This operational sequence repeats, at step 1110, as long as there are more strings to check for number of operational solar panels. If there is/are no more string(s) to check, at step 1110 then the processor 1202 exits, at step 1112.

### Example of a Solar Power Generation System Including a Processing System Operating in a Network

FIG. 12 illustrates an example of a processing system 1200 (also referred to as a computer system) suitable for use to perform the example methods discussed herein in a photovoltaic electrical power generation system 102, according to an example of the present disclosure. The processing system 1200 according to the example is communicatively coupled with a communication network 146 which can comprise a plurality of networks. This simplified example is not intended to suggest any limitation as to the scope of use or function of various example embodiments of the invention described herein.

The example processing system 1200 comprises a computer system/server, which is operational with numerous other general purpose or special purpose computing system environments or configurations. Examples of well-known computing systems, environments, and/or configurations that may be suitable for use with such a computer system/server include, but are not limited to, personal computer systems, server computer systems, thin clients, thick clients, hand-held or laptop devices, multiprocessor systems, microprocessor-based systems, and distributed cloud computing environments that include any of the above systems and/or devices, and the like.

The processing system 1200 may be described in a general context of computer system executable instructions, such as program modules, being executed by one or more processors 1202 in a computer system 1200. Generally, program modules may include methods, functions, routines, programs, objects, components, logic, data structures, and so on that perform particular tasks or implement particular abstract data types. A processing system 1200, according to various embodiments, may be practiced in distributed networking environments where tasks are performed by remote processing devices that are linked through a communications network.

Referring more particularly to FIG. 12, the following discussion will describe a more detailed view of an example processing system 1200. According to the example, at least one processor 1202 is communicatively coupled with system main memory 1204 and persistent memory 1206.

A bus architecture 1208 facilitates communicative coupling between the at least one processor 1202 and the various component elements of the processing system 1200. The bus architecture 1208 represents one or more of any of several types of bus structures, including a memory bus, a peripheral bus, an accelerated graphics port, and a processor bus or local bus using any of a variety of bus architectures.

The system main memory 1204, in one example, can include computer system readable media in the form of volatile memory, such as random access memory (RAM) and/or cache memory. By way of example only, a persistent memory storage system 1204 can be provided for reading from and writing to any one or more of: a non-removable, non-volatile magnetic media (not shown and typically called a “hard drive”), or a solid-state drive (SSD) (also not shown), or both. In such instances, each persistent memory storage system 1204 can be connected to the bus architecture 1208 by one or more data media interfaces. As will be further depicted and described below, the at least one processor 1202, the main memory 1204, and the persistent memory 1206, may include a set (e.g., at least one) of program modules 1207 that can be configured to carry out functions and features of various embodiments of the invention.

A program/utility, having a set (at least one) of program modules 1207, may be stored in persistent memory 1206 by way of example, and not limitation, as well as an operating system 1224, one or more application programs or applications 1226, other program modules, and program data. Each of the operating system 1224, one or more application programs 1226, other program modules, and program data, or some combination thereof, may include an implementation of interface software to a networking environment. Program modules generally may carry out the functions and/or methodologies of various embodiments of the invention as described herein. The processor 1202, according to various embodiments, can be communicative coupled with a data repository 1222, such as one or more PV Power Safety Data bases 1222.

The data repository 1222, for example, can maintain a history of weather and/or ambient conditions which is updated by the processor 1202 over time while the power generation system 102 is in operation. The processor 1202 can refer to this history information in the data repository 1222 to support its analysis of current information received from various sources of weather and ambient conditions at the solar array field. In this way, the processor 1202 can determine the likely occurrence of imminent weather and/or ambient conditions affecting the operation of the solar farm and the power generation system 102.

The processing system 1200, in various embodiments, can include a computer readable medium 1220 allowing a computer to read data, instructions, messages or message packets, and other computer readable information from the computer readable medium. For example, at least some of the instructions 1207 can be stored in such a computer readable medium. The computer readable medium 1220 may include computer readable storage medium embodying non-volatile memory, such as read-only memory (ROM), flash memory, disk drive memory, CD-ROM, and other permanent storage. Additionally, a computer readable medium may include volatile storage such as RAM, buffers, cache memory, and network circuits. In the present example, the computer readable medium 1220 is embodied as storage medium in a computer storage device 1218. The storage medium 1220 in the example is not permanent and can be removed by a user from, or installed into, the computer storage device 1218.

Furthermore, in embodiments other than in a tangible storage medium 1220, the computer readable medium may comprise computer readable information in a transitory state medium such as a network link and/or a network interface, including a wired network or a wireless network that allow a computer to read such computer readable information. In general, the computer readable medium embodies a computer program product as a tangible computer readable storage medium that embodies computer readable program code with instructions to control a machine to perform the above-described methods and realize the above-described systems.

The at least one processor 1202 is communicatively coupled with one or more network interface devices 1216 via the bus architecture 1208. The network interface device 1216 is communicatively coupled, according to various embodiments, with one or more networks 146. The network interface device 1216 can communicate with one or more networks 146 such as a local area network (LAN), a general wide area network (WAN), a wireless network, and/or a public network (e.g., the Internet). The network interface device 1216, according to the example, facilitates communication between the processing system 1200 and other nodes in the network(s) 146, such as a weather forecast source server system 148 and/or an administrative network operation control server system 150, as has been discussed above.

For example, the processor 1202 in the PV Power Plant Safety Controller 140, according to various embodiments, can transmit (via communication output 144) instructions and data to the one or more controllers operating in the photovoltaic electrical power generation system 102, in support of maintaining safe operation of the system 102. The processor 1202, for example, can also receive (via communication input 142) data from the one or more controllers.

A user interface 1210 is communicatively coupled with the at least one processor 1202, such as via the bus architecture 1208. The user interface 1210, according to the present example, includes a user output interface 1212 and a user input interface 1214. Examples of elements of the user output interface 1212 can include a display, a speaker, one or more indicator lights, one or more transducers that generate audible indicators, and a haptic signal generator. Examples of elements of the user input interface 1214 can include a keyboard, a keypad, a mouse, a track pad, a touch pad, and a microphone that receives audio signals. The received audio signals, for example, can be converted to electronic digital representation and stored in memory, and optionally can be used with voice recognition software executed by the processor 1202 to receive user input data and commands.

Computer instructions 1207 can be at least partially stored in various memory locations in the processing system 1200. For example, at least some of the instructions 1207 may be stored in any one or more of the following: in an internal cache memory in the one or more processors 1202, in the main memory 1204, and in the persistent memory 1206.

The instructions 1207, according to the example, can include computer instructions, data, configuration parameters, and other information that can be used by the at least one processor 1202 to perform features and functions of the processing system 1200 and of the photovoltaic electrical power generation system 102.

According to the present example, the instructions 1207 include a sensors network monitor 128 which, interoperating with the processor(s) 1202, causes operations of the processing system 1200, according to the example methods and process as discussed above with reference to FIGS. 6 to 11, to collect sensor information from various sensors distributed in the solar farm and the power generation system 102. The instructions 1207 also include a PV Power Control Manager 1230 which, interoperating with the processor(s) 1202, causes operations of the processing system 1200, according to the example methods and process as discussed above with reference to FIGS. 6 to 11, to transmit commands/instructions to, to monitor the operations of, and to collect data received from, the several controllers operating in the solar farm and the power generation system 102, in support of maintaining safe operation of the power generation system 102.

### Non-Limiting Examples

The present invention may be implemented as a system and/or a method, at any possible technical detail level of integration. A computer program may include computer readable program instructions thereon for causing a processor to carry out aspects of the present invention.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages. The computer readable program instructions may execute entirely on a user's computer, partly on a user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer programs, according to various embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special-purpose computer, or other programmable data processing apparatus to produce a machine, such that the instructions, which execute via the processor of the computer or other programmable data processing apparatus, implement the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the functions/acts specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer programs, according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present specification may describe components and functions implemented in the embodiments with reference to particular standards and protocols, the invention is not limited to such standards and protocols. Each of the standards represents examples of the state of the art. Such standards are from time-to-time superseded by faster or more efficient equivalents having essentially the same functions.

The illustrations of examples described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this invention. Figures are also merely representational and may not be drawn to scale. Certain proportions thereof may be exaggerated, while others may be minimized. Accordingly, the specification and drawings are to be regarded in an illustrative rather than a restrictive sense.

The Abstract is provided with the understanding that it is not intended be used to interpret or limit the scope or meaning of the claims. In addition, in the foregoing Detailed Description, various features are grouped together in a single example embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The terms “communicatively coupled” or “communicatively coupling” include, but are not limited to, communicating electronic control signals by which one element may direct or control another. The term “configured to” describes hardware, software or a combination of hardware and software that is set up, arranged, built, composed, constructed, designed or that has any combination of these characteristics to carry out a given function. The term “adapted to” describes hardware, software or a combination of hardware and software that is capable of, able to accommodate, to make, or that is suitable to carry out a given function.

The terms “controller”, “computer”, “processor”, “server”, “client”, “computer system”, “computing system”, “personal computing system”, “processing system”, or “information processing system”, describe examples of a suitably configured processing system adapted to implement one or more embodiments herein. A processing system may include one or more processing systems or processors. A processing system can be realized in a centralized fashion in one processing system or in a distributed fashion where different elements are spread across several interconnected processing systems.

The corresponding structures, materials, acts, and equivalents of all means or step plus function elements in the claims below are intended to include any structure, material, or act for performing the function in combination with other claimed elements as specifically claimed.

The description of the present application has been presented for purposes of illustration and description, but is not intended to be exhaustive or limited to the invention in the form disclosed. Many modifications and variations will be apparent to those of ordinary skill in the art without departing from the scope of the invention. The embodiments were chosen and described in order to best explain the principles of the invention and the practical application, and to enable others of ordinary skill in the art to understand the invention for various embodiments with various modifications as are suited to the particular use contemplated.

1. A method for safe operation of solar power generation equipment in a tracking solar array field during extreme and non-extreme operating conditions, the method comprising:
operating strings of tracking solar panels in a tracking solar array field which are electrically coupled to at least one combiner box that produces at its output a combined variable operating DC voltage at an input of an inverter, where a total number of operating tracking solar panels in at least one of the strings exceeds a rated maximum number of solar panels to maintain the combined variable operating DC voltage below a rated maximum DC voltage at the input of the inverter during extreme operating conditions that cause the combined variable operating DC voltage to exceed the rated maximum DC voltage;
determining if extreme operating conditions are imminent in the tracking solar array field;
in response to the determining, reducing the combined variable operating DC voltage to below the rated maximum DC voltage by at least one or more of:
a) electrically switching in a shunt load at the input of the inverter that reduces the combined variable operating DC voltage at the input of the inverter;
b) electrically switching in a shunt load at the output of the at least one combiner box that reduces the combined variable operating DC voltage at the output of the at least one combiner box;
c) mechanically tilting at least a subset of the operating tracking solar panels to a solar stow tilt position that reduces the combined variable operating DC voltage to below the rated maximum DC voltage; or
any combination of two or more of a), b), or c).

2. The method of claim 1, wherein the solar stow tilt position directs the at least a subset of the operating tracking solar panels to face a direction that avoids pointing toward direct sunlight from the sun at sunrise.

3. The method of claim 1, wherein the solar stow tilt position coincides with an inclement weather stow tilt position for the at least a subset of the operating tracking solar panels.

4. The method of claim 1, wherein the determining if extreme operating conditions are imminent in the tracking solar array field comprises:
sensing temperature of a solar cell in a tracking solar panel in one of the strings is at or below a lowest historical temperature of a solar cell in the tracking solar array field.

5. The method of claim 1, wherein the determining if extreme operating conditions are imminent in the tracking solar array field comprises:
sensing ambient temperature in proximity to one of the tracking solar panels in one of the strings is at or below a lowest historical ambient temperature in the tracking solar array field.

6. The method of claim 1, wherein the determining if extreme operating conditions are imminent in the tracking solar array field comprises:
sensing solar irradiance in proximity to a solar cell in a tracking solar panel in one of the strings is at or above a highest historical solar irradiance in the tracking solar array field.

7. The method of claim 1, wherein the determining if extreme operating conditions are imminent in the tracking solar array field comprises:
querying a weather forecast source and receiving therefrom information that predicts imminent weather and/or ambient conditions at the tracking solar array field, and determining that the imminent weather and/or ambient conditions are extreme operating conditions predicted to occur in the tracking solar array field within several hours during a day or in the next day.

8. The method of claim 1, wherein the determining if extreme operating conditions are imminent in the tracking solar array field comprises:
sensing solar irradiance in proximity to a solar cell in a tracking solar panel in one of the strings is at or above a highest historical solar irradiance in the tracking solar array field, and
at least one of:
sensing temperature of a solar cell in a tracking solar panel in one of the strings is at or below a lowest historical temperature of a solar cell in the tracking solar array field, or
sensing ambient temperature in proximity to one of the tracking solar panels in one of the strings is at or below a lowest historical ambient temperature in the tracking solar array field.

9. The method of claim 8, wherein the highest historical solar irradiance in the tracking solar array field is at least 800 W/m² or higher.

10. The method of claim 8, wherein
the lowest historical temperature of a solar cell in the tracking solar array field is at or below −10 degrees Centigrade or lower; and
the lowest historical ambient temperature is at or below −10 degrees Centigrade or lower.

11. The method of claim 1, wherein in response to the determining, reducing the combined variable operating DC voltage to at or below the rated maximum DC voltage by at least one or more of:
a) electrically switching in a shunt load at the input of the inverter that reduces the combined variable operating DC voltage at the input of the inverter;
b) electrically switching in a shunt load at the output of the at least one combiner box that reduces the combined variable operating DC voltage at the output of the at least one combiner box;
c) mechanically tilting at least a subset of the operating tracking solar panels to a solar stow tilt position that reduces the combined variable operating DC voltage to below the rated maximum DC voltage;
d) electrically switching in a shunt load at the output of one or more strings which reduces a variable operating DC voltage at the output of each of the one or more strings and further reduces the combined variable operating DC voltage at the output of the at least one combiner box; or
any combination of two or more of a), b), c) or d).

12. The method of claim 1, further comprising:
determining that the extreme operating conditions have ceased in the tracking solar array field; and
in response to the determining that the extreme operating conditions have ceased, performing at least one of:
a) electrically switching out a shunt load at the input of the inverter;
b) electrically switching out a shunt load at the output of the combiner box;
c) mechanically tilting at least a subset of the operating tracking solar panels from a solar stow tilt position to a solar tracking operation that returns the at least a subset to tracking a direction of sunlight from the sun; or
any combination of two or more of a), b), or c).

13. A photovoltaic electrical power generation system comprising:
a tracking solar array field including a plurality of tracking solar panels (PV's) organized in one or more strings of PV's;
at least one combiner box operatively coupled with a combiner box controller, wherein the at least one combiner box is electrically coupled to the one or more strings of PV's to receive harvested solar power as variable DC voltage and current from an output of the one or more strings of PV's;
an inverter equipment operatively coupled with an inverter controller, wherein an input of the inverter equipment is electrically coupled to an output of the at least one combiner box to receive into the inverter equipment a combined variable operating DC voltage from the at least one combiner box, and wherein a total number of operating tracking solar panels in at least one of the strings exceeds a rated maximum number of solar panels to maintain the combined variable operating DC voltage below a rated maximum DC voltage at the input of the inverter equipment during extreme operating conditions that cause the combined variable operating DC voltage to exceed the rated maximum DC voltage;
a photovoltaic power plant safety controller including:
a computer processor;
memory, coupled to the computer processor; and
one or more network interface devices, coupled to the computer processor, and which are further communicatively coupled with a computer network that is coupled to:
the combiner box controller; and
the inverter controller; and wherein
the computer processor, in response to executing computer instructions, performs a method comprising:
determining if extreme operating conditions are imminent in the tracking solar array field;
in response to the determining, reducing the combined variable operating DC voltage to at or below the rated maximum DC voltage by at least one or more of:
a) electrically switching in a shunt load at the input of the inverter equipment that reduces the combined variable operating DC voltage at the input;
b) electrically switching in a shunt load at the output of the combiner box that reduces the combined variable operating DC voltage at the output;
c) mechanically tilting at least a subset of the operating tracking solar panels to a solar stow tilt position that reduces the combined variable operating DC voltage to at or below the rated maximum DC voltage; or
any combination of two or more of a), b), or c).

14. The photovoltaic electrical power generation system of claim 13, wherein the
one or more network interface devices are further communicatively coupled with a wide area computer network that is communicatively coupled to a weather forecast source comprising a server communicatively coupled to the wide area computer network; and wherein
the computer processor, in response to executing computer instructions, performs the following method:
querying the weather forecast source and receiving therefrom information that predicts imminent weather and/or ambient conditions at the tracking solar array field, and determining that the imminent weather and/or ambient conditions are extreme operating conditions predicted to occur in the tracking solar array field within several hours during a day or in the next day.

15. The photovoltaic electrical power generation system of claim 13, wherein the computer processor, in response to executing computer instructions, performs the method further comprising:
determining that the extreme operating conditions have ceased in the tracking solar array field; and
in response to the determining that the extreme operating conditions have ceased, performing at least one of:
a) electrically switching out a shunt load at the input of the inverter equipment;
b) electrically switching out a shunt load at the output of the combiner box;
c) mechanically tilting at least a subset of the operating tracking solar panels from a solar stow tilt position to a solar tracking operation that returns the at least a subset to tracking a direction of sunlight from the sun; or
any combination of two or more of a), b), or c).

16. The photovoltaic electrical power generation system of claim 15, wherein the computer processor, in response to executing computer instructions, performs the method further comprising:
in response to the determining that the extreme operating conditions have ceased, performing at least one of:
a) electrically switching out a shunt load at the input of the inverter equipment;
b) electrically switching out a shunt load at the output of the combiner box;
c) mechanically tilting at least a subset of the operating tracking solar panels from a solar stow tilt position to a solar tracking operation that returns the at least a subset to tracking a direction of sunlight from the sun; or
d) electrically switching out a shunt load at the output of one or more strings which increases a variable operating DC voltage at the output of each of the one or more strings and thereby increases the combined variable operating DC voltage, and below the rated maximum DC voltage, at the output of the at least one combiner box; or
any combination of two or more of a), b), c) or d).

17. The photovoltaic electrical power generation system of claim 13, wherein the computer processor, in response to executing computer instructions, performs the method further comprising:
determining if extreme operating conditions are imminent in the tracking solar array field by
sensing solar irradiance in proximity to a solar cell in a tracking solar panel in one of the strings is at or above a highest historical solar irradiance in the tracking solar array field, and
at least one of:
sensing temperature of a solar cell in a tracking solar panel in one of the strings is at or below a lowest historical temperature of a solar cell in the tracking solar array field, or
sensing ambient temperature in proximity to one of the tracking solar panels in one of the strings is at or below a lowest historical ambient temperature in the tracking solar array field.

18. The photovoltaic electrical power generation system of claim 17, wherein the highest historical solar irradiance in the tracking solar array field is at least 800 W/m² or higher.

19. The photovoltaic electrical power generation system of claim 17, wherein
the lowest historical temperature of a solar cell in the tracking solar array field is at or below −10 degrees Centigrade or lower, and
the lowest historical ambient temperature is at or below −10 degrees Centigrade or lower.

20. The photovoltaic electrical power generation system of claim 13, wherein
the solar stow tilt position directs the at least a subset of the operating tracking solar panels to face a direction that avoids pointing toward direct sunlight from the sun at sunrise.
